(19) United States
(12) Patent Application Publication
(10) Pub. No.: US 2011/0307192 A1
(43) Pub. Date: Dec. 15, 2011

(54) MASS FLOW METERING SYSTEM FOR AIRCRAFT APPLICATIONS

(76) Inventor: Leo J. Veilleux, Wethersfield, CT (US)

(21) Appl. No.: 12/815,575

(22) Filed: Jun. 15, 2010

(51) Int. Cl. G01F 1/34

(52) U.S. Cl. 702/47

(57) ABSTRACT

A method of calculating fuel flow across an aircraft flight cycle includes the steps of providing a flow meter, and an alternative method of measuring fuel flow. The flow meter is used to calculate fuel flow over a portion of a flight cycle of an aircraft equipped with the system. Fuel flow is calculated with the alternative measurement system at least during maximum power flow portions of the flight cycle. A system is configured for performing this method. A method of calculating mass flow across a fuel metering unit uses fuel flow volume measurements and information about the fuel to reach a mass flow measurement.

### BACKGROUND

This application relates to a hybrid method of monitoring fuel flow for an aircraft engine.

Aircraft are typically provided with a gas turbine engine that has a wide range of power requirements across a flight cycle. As an example, an aircraft typically idles on the runway or tarmac for a period of time at a low power, low fuel burn.

At take-off, there is a higher power flow requirement, and thus higher fuel burn. On the other hand, the bulk of the operation of the aircraft is after take-off, and at a power and fuel flow level much lower than the maximum power flow for take-off. As an example, this may be 20 to 40% of the maximum power flow level at a cruise flow level.

Modern aircraft are provided with very precise computer controls and diagnostic equipment. An accurate identification of the fuel burn across the flight cycle is important for use by any number of controls. To date, it has been known to utilize a flow meter that measures the fuel flow. Since the maximum power flow is so much higher than the cruise flow, the flow meter must be relatively large to handle the maximum flow, even though that maximum flow occurs over only a very short portion of the overall flight cycle.

Fuel metering units are also known, and receive electric controls to precisely control the amount of fuel passing to the gas turbine engine. The fuel metering units have typically been used solely to provide metering across an orifice, and by an established pressure differential. In addition to fuel metering units utilizing a controlled orifice, other types of metering systems are known, including those using variable speed pistons, gears or vanes, and variable displacement systems.

### SUMMARY

A method of calculating fuel flow across an aircraft flight cycle includes the steps of providing a flow meter, and an alternative method of measuring fuel flow. The flow meter is used to calculate fuel flow over a portion of a flight cycle of an aircraft equipped with the system. Fuel flow is calculated with the alternative measurement system at least during maximum power flow portions of the flight cycle. A system is also disclosed and claimed.

A method of calculating the fuel usage using a fuel metering unit is also disclosed and claimed.

These and other features of the present invention can be best understood from the following specification and drawings, the following of which is a brief description.

### BRIEF DESCRIPTION OF THE DRAWINGS

FIG. 1 schematically shows an aircraft fuel system.

FIG. 2 is a schematic flow chart of this application.

FIG. 3 shows exemplary effects of the proposed method.

### DETAILED DESCRIPTION

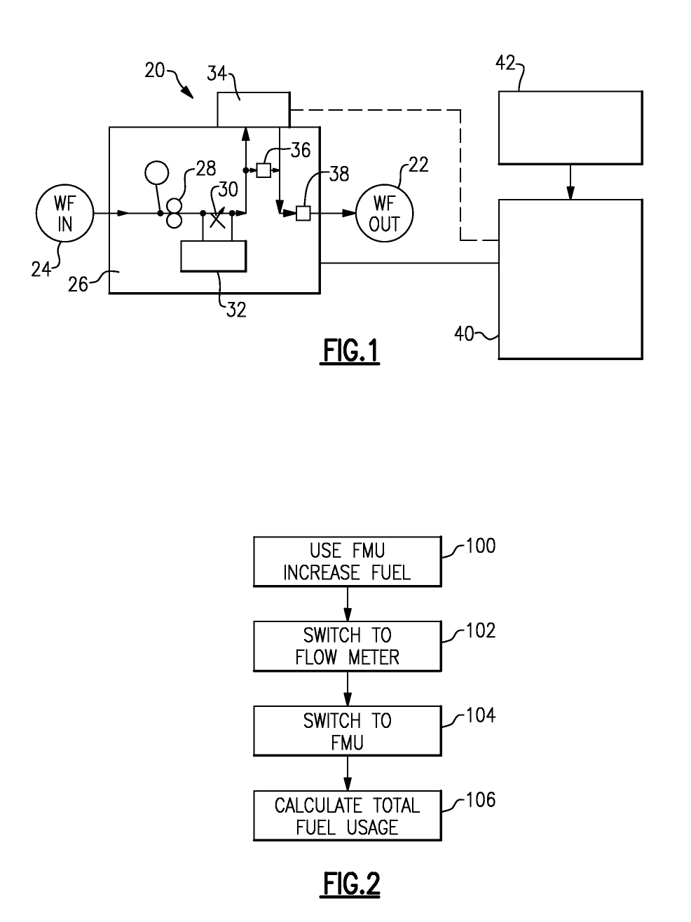

FIG. 1 illustrates an aircraft fuel system 20 for delivering fuel to an aircraft gas turbine engine 22. The fuel is delivered from a fuel tank 24, through a flow metering unit 26 (FMU). A gear pump 28 drives the fuel across an orifice 30. A set pressure drop is provided by element 32 as measured across the orifice 30. By setting the pressure drop, optionally measuring the pressure drop, a prediction can be made of the fuel mass flowing through the orifice 30. The orifice metering measurements are delivered to an engine controller 40. Aircraft data 42 is also delivered to the controller 40. The calculations and use of the fluid flow information by the engine controller 40 is as known in the art. The engine controller 40 can include one or more microcontrollers, memory, input/output interfaces, and/or additional circuitry configured to interface with the FMU 26 and other components of the aircraft gas turbine engine 22.

FMUs have typically been utilized to simply meter the amount of fuel traveling downstream. However, as further described herein, FMUs can also be utilized to measure mass flow. In fact, the flow metering unit 26 does measure volume flow, as known. This volume flow information is utilized in combination with known fuel information, such as fuel temperature and the type of fuel, and at the controller 40 to identify a density. That is, the controller 40 can be provided with look-up tables, etc., and a way of identifying or measuring fuel temperature and the type of fuel. The type of fuel in the aircraft and fuel density information can be stored in the aircraft data 42 and provided to the controller 40. The fuel temperature information can be used to account for temperature-based volume adjustments. The look-up tables can then be consulted to identify a fuel density. Once fuel density is known, it may be utilized in combination with volume flow information to reach a mass flow amount.

A mass flow meter 34 can also be utilized in conjunction with the FMU 26, as will be described below. The mass flow meter 34 provides a mass flow measurement which can be compared to the volume flow measurement from the FMU 26, at one instance, such as at a steady state period in fuel use. The density can then be identified from these two amounts. Once the density of the fuel is known, that information can be utilized in combination with future volume fuel flow measurements to know mass flow across the FMU 26.

The above methods of utilizing an FMU to reach a mass flow amount can be utilized with any number of types of FMUs, and not simply the orifice 30 as disclosed above. Also, other ways of transforming a volume measurement into mass flow measurement may be used.

Typically, the calculation of total fuel use during a flight cycle is provided by passing the flow through mass flow meter 34, then through a shut-off valve 38 to the engine 22. The mass flow meter 34 is sized such that it can handle the entire power range across a flight cycle.

Since the power range has relatively high points during a flight cycle, the mass flow meter 34 in the prior art has been unduly large. In addition, since it is large, it is not as accurate as would be desired during the bulk of the flight cycle, which occurs at cruise conditions.

Using a hybrid method of flow measurements with a flow meter measurement, and an alternative measuring system, such as the flow metering unit 26, or other appropriate measurement, the size of the mass flow meter 34 can be reduced and accuracy of flow determination can be increased.

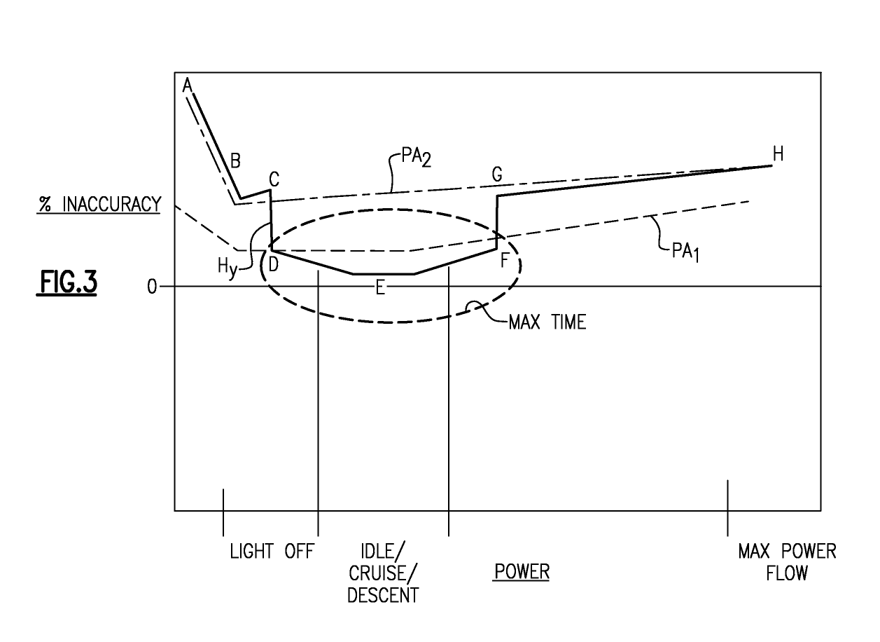

As shown in FIG. 2, a flow chart of this application includes an initial step (step 100) of utilizing the FMU information at low power start. Further, during a normal flight cycle, the power flow and fuel flow increase dramatically at take-off or climb. During this interval, the FMU information is utilized.

At the maximum flow take-off, a bypass valve 36 of FIG. 1 may be entirely or partially opened to entirely bypass the mass flow meter 34. This can occur during this entire initial step (step 100). On the other hand, the bypass valve 36 may be designed to be entirely closed such that the mass flow meter 34 information is utilized by the controller 40 at the lower power range. Then, the controller 40 may switch to the FMU 26 at higher power range, such as take-off. The bypass valve 36 may simply be a pressure relief spring biased valve which opens when pressure builds up on the line leading into the bypass valve 36.

After take-off (step 102), the controller 40 switches to using the mass flow meter 34. If the bypass valve 36 had been previously opened, it is closed. The mass flow meter 34 is utilized for the entire time of cruise, and may also be utilized at descent. However, as the fuel usage decreases (step 104), the controller 40 may switch back to use of the FMU 26, such as for taxiing to return to a terminal.

Total fuel usage may then be calculated by the controller 40 (step 106).

As shown in FIG. 3, a prior art mass flow meter use is identified by the line PA₁. At cruise, it is relatively accurate, however, its inaccuracy does increase at higher power flow. There are tradeoffs with increasing the accuracy at higher power flow that would reduce the accuracy at cruise.

Line PA₂ is the prior art accuracy if the FMU 26 of FIG. 1 is relied upon entirely. As shown, the FMU 26 is not as accurate as would be desired, and thus the mass flow meter 34 has typically been utilized instead of the FMU 26 across the entire flight cycle.

The hybrid method as previously described is shown by line H_{y}. As can be seen, the hybrid method is very accurate during the portion identified by the circled oval, which is idle/cruise/descent. In fact, since the mass flow meter 34 can be sized for the particular amount of fuel delivered during this time interval, the accuracy of the flow meter portion of H_{y} is increased compared to the accuracy of the mass flow meter PA₁ during the same time period. This is true since the mass flow meter 34 can be more appropriately sized for the particular range of operation, compared to the prior art which needs to be operable across the entire power range. Thus, not only may a smaller flow meter be utilized, but more accurate results are obtained. Since the accuracy is increased over the bulk of the flight, the overall results are much more accurate than the prior art.

In addition, while a mass flow meter has been disclosed, other types of flow meters may be utilized.

In a typical flight cycle illustrated in FIG. 3, the time spent in the range D-E-F is the great bulk of the time of operation. The maximum power flow G-H is only a minimal amount of time, as is the light off or low power range A-B-C. Transition ranges C-D and F-G can be established as switching ranges where the controller 40 transitions from using the FMU 26 for flow calculations to using mass flow meter 34 and back to FMU 26. Values for desired switching points for transition ranges C-D and F-G may be provided via aircraft data 42.

It should be understood that FIG. 3 is not chronologically oriented, but rather shows the amount of power utilized compared to the resultant inaccuracy in the measurements. In fact, the time period at cruise will be the great bulk of the time for any typical flight cycle.

The method includes the use of the mass flow meter 34 of FIG. 1 only over a limited range of fuel use, but over the maximum amount of flight time. The term “cruise” is well defined in the aircraft industry, and a worker of ordinary skill in the art would recognize what is meant by cruise. The mass flow meter 34 would be utilized at least during the bulk of the cruise operation, but the FMU 26 utilized otherwise. Cruise could be defined as the percentage of the maximum fuel flow on the order of 20-40%; however, this range is merely an example. Stated another way, the cruise portion would be some component of 20-40% of the maximum fuel flow. The use of the mass flow meter 34 within the disclosed method would occur at least some portion of this range. Thus, the FMU 26 may be used as an alternative system and method of measuring fuel flow in conjunction with the mass flow meter 34.

In addition, the controller 40 can use the flow meter data to make the mass meter function of the FMU 26 more accurate. Software within the controller 40 can calibrate the FMU 26 in the cruise/steady state range such that it can gain improved accuracy, thereby making the FMU mass flow readings more accurate over its entire range. This can improve the accuracy over time, so that the next flight cycle would be even more accurately measured.

In addition, the bypass valve 36 may or may not be utilized when the mass flow meter information is not being utilized. That is, the mass flow meter 34 could be bypassed or not, and the method simply directed to which of the two pieces of information are utilized by the engine controller 40 to calculate total fuel flow.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of calculating fuel usage across an aircraft flight cycle comprising the steps of:
(a) providing a flow meter, and an alternative method of measuring fuel flow;
(b) utilizing said flow meter to determine fuel flow to a gas turbine engine, and sending information from said flow meter to a controller at least over a portion of a flight cycle of an aircraft as a flow meter portion; and
(c) determining fuel flow with said alternative method, and utilizing information from said alternative method at said controller at least during maximum power portions of the flight cycle, in combination with said information from step (b) to determine a total fuel usage during the flight cycle.

2. The method as set forth in claim 1, wherein said alternative method is also utilized during low power portions of the flight cycle.

3. The method as set forth in claim 1, wherein said flow meter portion is at least a part of a range of 20-40% of maximum power.

4. The method as set forth in claim 1, wherein said alternate method is a device utilizing an orifice and a pressure differential across the orifice to calculate fuel flow.

5. The method as set forth in claim 1, wherein said flow meter is bypassed during at least the maximum power portions of the flight cycle.

6. The method as set forth in claim 1, wherein said alternative method of measuring fuel flow initially measures a fuel flow volume, this volume is then compared to information from said flow meter, and information with regard to the fuel is then identified and utilized in combination with future fuel flow volume measurement as said information from said alternative method.

7. The method as set forth in claim 6, wherein said information with regard to the fuel comprises fuel temperature, fuel type, and density, and further wherein said fuel flow volume measurements are compensated for said fuel temperature to determine mass flow as a function of said fuel type and said density.

8. The method as set forth in claim 1, wherein said flow meter is a mass flow meter and said alternative method of measuring fuel flow is calculated from volume flow measurements of a fuel metering unit.

9. A system for monitoring total fuel usage on an aircraft comprising:
a flow meter, and an alternative system for measuring fuel flow;
said flow meter determining fuel flow to a gas turbine engine, and sending information to a controller at least over a portion of a flight cycle of an aircraft as a flow meter portion;
said alternative system sending information to said controller at least during maximum power flow portions of the flight cycle; and
said controller determining a total fuel usage during the flight cycle by utilizing information from both said flow meter and said alternative system.

10. The system as set forth in claim 9, wherein said alternative system is also utilized during low flow portions of the flight cycle.

11. The system as set forth in claim 9, wherein said flow meter portion is at least a portion of a range of 20-40% of maximum power.

12. The system as set forth in claim 9, wherein said alternate system is a device utilizing an orifice and a pressure differential across the orifice to calculate fuel flow.

13. The system as set forth in claim 9, wherein said flow meter is bypassed during at least the maximum power portions of the flight cycle.

14. The system as set forth in claim 9, wherein said alternative system measures a fuel flow volume, said controller comparing this volume to information from said flow meter, and information with regard to the fuel is then identified and utilized in combination with future fuel flow volume measurement as said information from said alternative system at said controller.

15. The system as set forth in claim 14, wherein said information with regard to the fuel comprises fuel temperature, fuel type, and density, and further wherein said fuel flow volume measurements are compensated for said fuel temperature to determine mass flow as a function of said fuel type and said density.

16. The system as set forth in claim 9, wherein said flow meter is a mass flow meter and said alternative system for measuring fuel flow is a fuel metering unit.

17. A method of calculating fuel usage across an aircraft flight cycle comprising the steps of:
a) metering a volume of fuel across a fuel metering unit;
b) measuring a fuel flow volume across the fuel metering unit;
c) utilizing said measured fuel flow volume information in combination with information on a fuel to change to fuel flow volume information into mass flow information; and
d) determining a total fuel usage across a flight cycle at least utilizing said mass flow information.

18. The method as set forth in claim 17, wherein said method of measuring fuel flow volume includes providing a pressure drop across an orifice, and utilizing said pressure drop to determine said fuel flow volume.

19. The method as set forth in claim 17, wherein the fuel flow volume is compared to a mass flow amount measured by a mass flow meter, and the information on the fuel is identified from this comparison, the information on the fuel then being utilized for future fuel flow volume readings to reach said mass flow information.

20. The method as set forth in claim 17, wherein the fuel flow volume is compared to a mass flow amount measured by a mass flow meter, and the mass flow amount measured by the mass flow meter is utilized to calibrate at least one of the fuel flow volume information and the mass flow information.
